(19) United States
(12) Patent Application Publication
(10) Pub. No.: US 2011/0229074 A1
(43) Pub. Date: Sep. 22, 2011

(54) OPTICAL WAVEGUIDE DEVICE AND OPTICAL RECEIVER WITH SUCH OPTICAL WAVE GUIDE DEVICE

(75) Inventor: Seok-Hwan JEONG, Kawasaki (JP)

(73) Assignee: FUJITSU LIMITED, Kawasaki-shi (JP)

(21) Appl. No.: 13/048,968

(22) Filed: Mar. 16, 2011

(30) Foreign Application Priority Data
Mar. 18, 2010 (JP) 2010-62483

(51) Int. Cl. G02B 6/26

(52) U.S. Cl. 385/28

(57) ABSTRACT

An optical waveguide device includes two input channels, a plurality of output channels, and a multi-mode interference coupler having one end part coupled to the two input channels and the other end part coupled to the plurality of output channels, the multi-mode interference coupler has a pair of opposite side parts, the multi-mode interference coupler has a width defined by the pair of opposite side parts and the width gradually increases from one end part to the other end part, and the two input channels are asymmetrically coupled to the one end part with respect to the center axis in the width direction.

### CROSS-REFERENCE TO RELATED APPLICATIONS

This application is based upon and claims the benefit of priority from the prior Japanese Patent Application No. 2010-62483 filed on Mar. 18, 2010, the entire contents of which are incorporated herein by reference.

### FIELD

The present invention relates to an optical waveguide device and an optical receiver with such an optical waveguide device.

### BACKGROUND

In recent years, an increase in bit rate has been desired to increase capacity of transmission in an optical communication system. In order to improve transmission capacity, for example, a multilevel phase modulation may be used without an increase in bit rate.

Specifically, examples of the multilevel phase modulation include a quadrature phase shift keying (QPSK) or a differential quadrature phase shift keying (DQPSK).

In order to demodulate a QPSK or DQPSK signal beam, for example, a coherent optical receiver with an optical hybrid circuit has been used. The optical hybrid circuit is a principle circuit in the coherent optical receiver. The optical hybrid circuit is designed to output four signal beams according to the phase state of the input QPSK or DQPSK signal beam and then take out multi-valued information.

A reduction in size of the optical hybrid circuit has been desired for the manufacturing for a coherent optical receiver having excellent cost performance.

FIG. 1 is a diagram illustrating a first example of the related art optical hybrid circuit.

An optical hybrid circuit 111 shown in FIG. 1 is constructed of four 3 dB couplers and a 90-degree phase shifter. The 3 dB couplers are coupled to one another via optical waveguides. In addition, the 90-degree phase shifter is coupled to the 3 dB couplers via optical waveguides. The optical hybrid circuit 111 receives both a QPSK signal beam and a local oscillation beam (LO beam) through two input channels. Then, four output beams with different phases each shifted by 90 degrees can be output from output channels, respectively. The output beams include S−L and S+L signal beams, which are the In-phase components, and S−jL and S+jL signal beams, which are the Quadrature-phase components.

However, the optical hybrid circuit 111 shown in FIG. 1 includes many elements for constructing the circuit, limiting the miniaturization of the optical hybrid circuit.

FIG. 2 is a diagram illustrating a second example of a related art optical hybrid circuit.

The optical hybrid circuit 112 shown in FIG. 2 includes four input channels, four output channels, and a rectangular 4:4 multi-mode interference (MMI) coupler. The optical hybrid circuit 112 receives a QPSK signal beam and a LO beam as inputs through two input channels among the four input channels, which are asymmetrical to the center axis of the coupler in the optical propagation direction. The input signal beam is self-imaged by multi-mode interference in the MMI coupler and four output beams are output with different phases each shifted by 90 degrees.

As compared with the optical hybrid circuit shown in FIG. 1, the optical hybrid circuit 112 has a simple structure and the size thereof in the optical propagation direction (hereinafter, simply referred to as a “device length”) can be shortened. The rectangular optical hybrid circuit shown in FIG. 2 has a given device length L_{MMI} proportional to the square of the width W_{MMI} (i.e., the size in the direction perpendicular to the optical propagation direction) of the optical hybrid circuit. Then, the rectangular optical hybrid circuit shown in FIG. 2 needs to reduce its width W_{MMI} to shorten the device length L_{MMI}.

However, to reduce the width W_{MMI} of the optical hybrid circuit while keeping the distance (“gap” in the figure) between the adjacent input channels as it is, the distance (gap) between the adjacent input channels should be shortened to reduce the width W_{MMI}. However, the reduction in distance (gap) is limited from a standpoint of processing accuracy in manufacturing steps, such as etching. Therefore, there is a limit in shortening the device length of the rectangular optical hybrid circuit shown in FIG. 2.

FIG. 3 is a diagram illustrating a third example of a related art optical hybrid circuit. An optical hybrid circuit 113 shown in FIG. 3 includes a MMI coupler where the both end parts thereof form a butterfly tapered shape. The width of the MMI coupler gradually decreases in tapered shape in the optical propagation direction and then gradually increases in reverse tapered shape. The width of the input side of the MMI coupler is W_{MMI} which is equal to that of the optical hybrid circuit 112 shown in FIG. 2. In contrast, the width of the middle of the MMI coupler in the optical propagation direction is W_{MB} which is smaller than the width W_{MMI} of the input side. Both end parts of the MMI coupler have discontinuous points on the regions corresponding to the width W_{MB} of the middle part. The optical hybrid circuit 113 having such a configuration is designed to reduce the device length by causing a decrease in average width.

FIG. 4 is a diagram illustrating a fourth example of the related art optical hybrid circuit. Each of the opposite side parts of an MMI coupler in an optical hybrid circuit 114 shown in FIG. 4 is in the form of an inwardly parabolic arch shape. The width of the MMI coupler parabolically decreases and then parabolically increases in the optical propagation direction. The width of the input side of the MMI coupler is W_{MMI} which is equal to that of the optical hybrid circuit 112 shown in FIG. 2. In contrast, the width of the middle part of the MMI coupler in the optical propagation is W_{MP} which is smaller than the width W_{MMI} of the input side thereof. The both side parts of the MMI coupler are continuous also at the middle part of the width W_{MP}. The optical hybrid circuit 114 having such a configuration is also designed to reduce the device length by causing a decrease in average width.

### SUMMARY

According to aspects of embodiments, an optical waveguide device includes two input channels, a plurality of output channels, and a multi-mode interference coupler having one end part coupled to the two input channels and the other end part coupled to the plurality of output channels, the multi-mode interference coupler has a pair of opposite side parts, the multi-mode interference coupler has a width defined by the pair of opposite side parts and the width gradually increases from one end part to the other end part, and the two input channels are asymmetrically coupled to the one end part with respect to the center axis in the width direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of the related art optical hybrid circuit;

FIG. 2 is a diagram illustrating a second example of the related art optical hybrid circuit;

FIG. 3 is a diagram illustrating a third example of the related art optical hybrid circuit;

FIG. 4 is a diagram illustrating a fourth example of the related art optical hybrid circuit;

FIG. 5 is a diagram illustrating an optical hybrid circuit according to a first embodiment disclosed in the present specification;

FIGS. 6A to 6C are diagrams each illustrating the positions of input channels coupled to a multi-mode interference coupler;

FIG. 7 is a diagram illustrating the relationship between the shortening rate and W_{M}/W_{S};

FIG. 8A is a diagram illustrating the relationship between the transmittance of each output channel and the wavelength of an input signal beam when the ratio of W_{S}/W_{M} is about 0.65;

FIG. 8B is a diagram illustrating the relationship between the relative phase deviation of each output channel and the wavelength of the input signal beam when the ratio of W_{S}/W_{M} is about 0.65;

FIG. 9A is a diagram illustrating the relationship between the transmittance of each output channel and the wavelength of an input signal beam when the ratio of W_{S}/W_{M} is about 0.53;

FIG. 9B is a diagram illustrating the relationship between the relative phase deviation of each output channel and the wavelength of the input signal beam when the ratio of W_{S}/W_{M} is about 0.53;

FIG. 10A is a diagram illustrating the transmittance of each output channel of the optical hybrid circuit shown in FIG. 3 and the wavelength of an input signal beam;

FIG. 10B is a diagram illustrating the relationship between the relative phase deviation of each output channel and the wavelength of the input signal beam;

FIG. 11 is a diagram illustrating a wavefront propagating in the optical hybrid circuit shown in FIG. 3;

FIG. 12 is a diagram illustrating a wavefront propagating in the optical hybrid circuit shown in FIG. 5;

FIG. 13A is a diagram illustrating the transmittance of each output channel of the optical hybrid circuit shown in FIG. 4 and the wavelength of an input signal beam;

FIG. 13B is a diagram illustrating the relationship between the relative phase deviation of each output channel and the wavelength of the input signal beam;

FIG. 14 is a diagram illustrating a wavefront propagating in the optical hybrid circuit shown in FIG. 4;

FIG. 15A is a diagram illustrating the relationship between the transmittance of each output channel of the optical hybrid circuit shown in FIG. 5 and the wavelength of an input signal beam when the distance (gap) between the output channels of this optical hybrid circuit is 1.0 μm (i.e., gap=1.0 μm);

FIG. 15B is a diagram illustrating the relationship between the relative phase deviation of each output channel and the wavelength of the input signal beam;

FIG. 16A is a diagram illustrating the relationship between the transmittance of each output channel of the optical hybrid circuit shown in FIG. 5 and the wavelength of an input signal beam when the distance (gap) between the output channels of this optical hybrid circuit is 1.0 μm (i.e., gap=1.0 μm);

FIG. 16B is a diagram illustrating the relationship between the transmittance of each output channel of the optical hybrid circuit shown in FIG. 2 and the wavelength of an input signal beam when the distance (gap) between the output channels of this optical hybrid circuit is 0.6 μm (i.e., gap=0.6 μm);

FIG. 17A is a diagram illustrating the relationship between the relative phase deviation of each output channel of the optical hybrid circuit shown in FIG. 5 and the wavelength of an input signal beam when the distance (gap) between the output channels of this optical hybrid circuit is 1.0 μm (i.e., gap=1.0 μm);

FIG. 17B is a diagram illustrating the relationship between the relative phase deviation of each output channel of the optical hybrid circuit shown in FIG. 2 and the wavelength of an input signal beam when the distance (gap) between the output channels of this optical hybrid circuit is 0.6 μm (i.e., gap=0.6 μm);

FIG. 18 is an enlarged cross-sectional diagram along the line X-X of FIG. 5;

FIG. 19 is a diagram illustrating the optical hybrid circuit according to a second embodiment disclosed in the present specification;

FIG. 20 is a diagram illustrating the optical hybrid circuit according to a third embodiment disclosed in the present specification;

FIG. 21 is a diagram illustrating the relationship between the shortening rate of the optical hybrid circuit of each of the first to third embodiments and the W_{M}/W_{S} thereof;

FIG. 22 is a diagram illustrating a coherent receiver according to one embodiment disclosed herein;

FIG. 23 is a diagram illustrating a coherent receiver according to another embodiment disclosed herein;

FIG. 24 is a diagram illustrating a modified example of the multi-mode interference coupler disclosed herein;

FIG. 25A is a diagram illustrating the transmittance of each output channel of the optical hybrid circuit of the first example and the wavelength of an input signal beam;

FIG. 25B is a partially enlarged diagram of FIG. 25A;

FIG. 25C is a diagram illustrating the relationship between the relative phase deviation of each output channel and the wavelength of the input signal beam;

FIG. 26A is a diagram illustrating the transmittance of each output channel of the optical hybrid circuit of the second example and the wavelength of an input signal beam, FIG. 26B is a partially enlarged diagram of FIG. 26A; and

FIG. 26C is a diagram illustrating the relationship between the relative phase deviation of each output channel and the wavelength of the input signal beam.

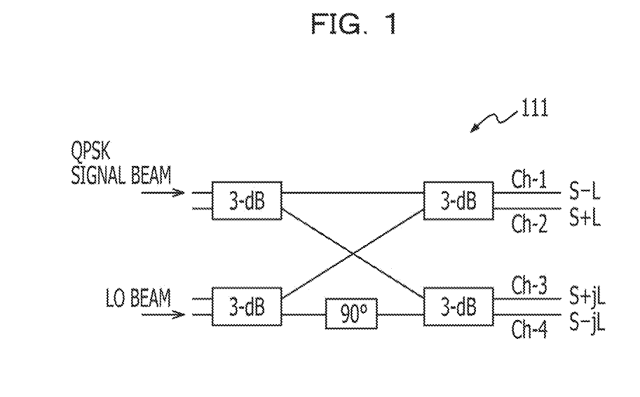

### DESCRIPTION OF EMBODIMENTS

Example embodiments will be explained with reference to accompanying drawings.

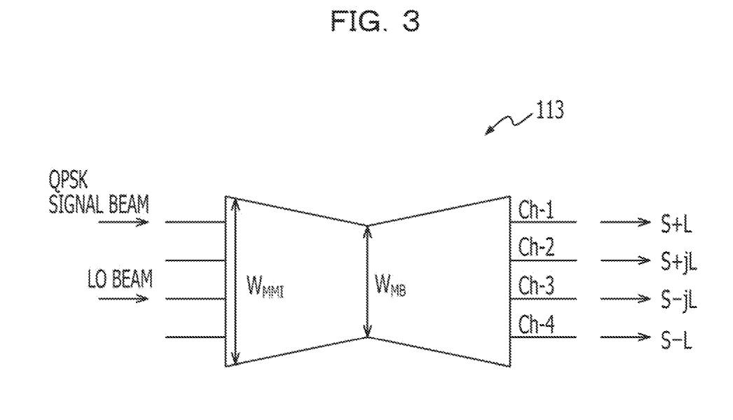

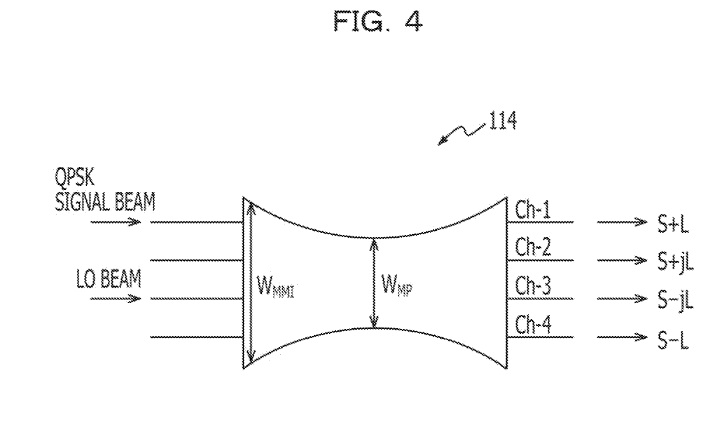

The configuration of each of the optical hybrid circuits shown in FIG. 3 and FIG. 4 can reduce the device length of the MMI coupler. However, further improvements have been desired for the optical hybrid circuits shown in FIG. 3 and FIG. 4 with respect to their optical characteristics, such as optical power balance for the output channels and low phase deviation for each output channel.

The optical hybrid circuit disclosed in the present specification is suitably used for inputting a multilevel phase-shift keying signal beam and discriminating the phase of the input signal to demodulate a multileveled signal.

The optical hybrid circuit disclosed in the present specification can be used for demodulating a multilevel phase-shift keying signal beam, such as BPSK, QPSK, or 8 PSK, or a multilevel amplitude-phase-shift keying signal beam, such as 16 QAM or 64 QAM. In the following description, an example of the optical hybrid circuit will be described for demodulation of a QPSK signal beam. The number of output channels of the optical hybrid circuit can be appropriately defined according to input signal beams, for example.

Hereinafter, an optical hybrid circuit (an example of the optical waveguide device) according to a first preferred embodiment disclosed in the present specification will be described with reference to the attached drawings. However, it is noted that the technical scope of the embodiments is not limited to that of those disclosed herein but interpreted within that of the claimed invention and the equivalents thereof.

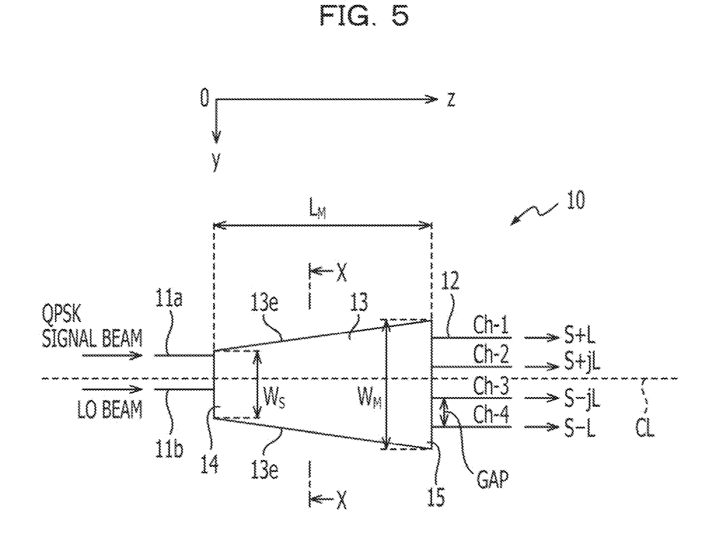

FIG. 5 is a diagram illustrating an optical hybrid circuit according to a first embodiment disclosed in the present specification.

The optical hybrid circuit 10 of the present embodiment includes two input channels 11a and 11b, four output channels 12, and a multi-mode interference coupler 13 where one end part 14 thereof is coupled to two input channels 11a and 11b and the other end part 15 thereof is coupled to four output channels 12.

The multi-mode interference coupler 13 allows a light beam to propagate from one end part 14 to the other end part 15.

In the present specification, the direction extending from one end part 14 to the other end part 15 of the multi-mode interference coupler 13 is also referred to as an “optical propagation direction”.

The multi-mode interference coupler 13 has a pair of opposite side parts 13e. The width of the multi-mode interference coupler 13 is defined by the pair of opposite side parts 13e. The multi-mode interference coupler 13 linearly increases in width from one end part 14 to the other end part 15. The width direction of the multi-mode interference coupler 13 is perpendicular to the direction extending from the one end part 14 to the other end part 15. The width direction of the optical hybrid circuit 10 coincides with the width direction of the multi-mode interference coupler 13.

The outermost side parts 13e that define the width of the multi-mode interference coupler 13 are formed symmetrically with respect to the center axis CL in the axial direction. In the optical hybrid circuit 10, the profile of each side part 13e of the multi-mode interference coupler 13 is linear.

One end part 14 of the multi-mode interference coupler 13 has a given width W_{S} and two input channels 11a and 11b are coupled to this end part 14.

The other end part 15 of the multi-mode interference coupler 13 has a given width W_{M} and four output channels 12 are coupled to this end part 15. In FIG. 5, four channels are numbered Ch-1, Ch-2, Ch-3, and Ch-4, respectively.

The width of the multi-mode interference coupler 13 is linearly increased from W_{S} to W_{M} to form a reverse taper shape in the optical propagation direction. In FIG. 5, the direction extending from one end part 14 to the other end part 15 of the multi-mode interference coupler 13 is represented as a positive direction along the z axis. In addition, the multi-mode interference coupler 13 in the width direction is represented by the y axis. In the optical hybrid circuit 10 shown in FIG. 5, the length of the multi-mode interference coupler 13 in the z axis direction is represented as L_{M.}

In the optical hybrid circuit 10, two input channels 11a and 11b are coupled to the other end part 14 in an asymmetrical manner with respect to the center axis CL in the width direction.

Next, a preferable position where two input channels 11a and 11b are coupled to one end part 14 of the multi-mode interference coupler 13 will be described below with reference to the drawings.

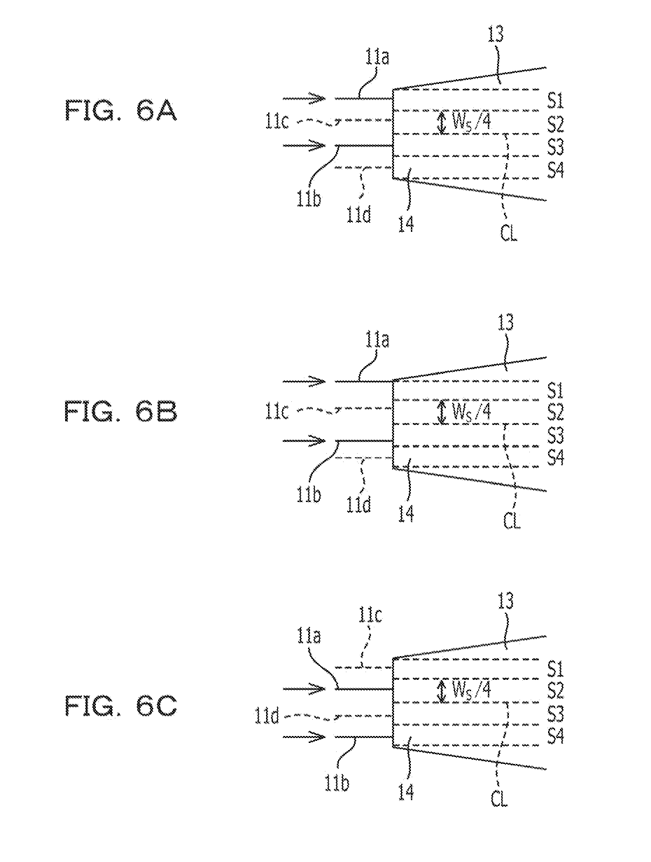

FIGS. 6A to 6C are diagrams illustrating examples of positions where two input channels 11a and 11b are coupled to the multi-mode interference coupler 13.

In FIGS. 6A to 6C, the other end part 13 of the multi-mode interference coupler 13 is divided into four sections in the width direction. In other words, the other end part 14 is divided into section S1, section S2, section S3, and section S4 in the width direction. Each of two input channels 11a and 11b is preferably coupled to two of the sections, which are positioned asymmetrically with respect to the center axis CL in the width direction corresponding to the boundary line between the section S2 and the section S3.

In the example shown in FIG. 6A, one input channel 11a is coupled to the section S1 and the other input channel 11b is coupled to the section S3. Both the section S1 and the section S3 are positioned asymmetrically with respect to the center axis CL in the width direction.

Even in the example shown in FIG. 6B, as well as FIG. 6A, one input channel 11a is coupled to the section 51 and the other input channel 11b is coupled to the section S3. However, the position in the width direction, where one input channel 11a is coupled to the section S1, is different from the position in the example shown in FIG. 6A. Similarly, the position in the width direction, where one input channel 11b is coupled to the section S3, is different from the position in the example shown in FIG. 6A. In this way, the positions where the input channels 11a and 11b are coupled to the respective sections may be any position in the sections in the width direction.

In the example shown in FIG. 6C, one input channel 11a is coupled to the section S2 and the other input channel 11b is coupled to the section S4. Both the section S2 and the section S4 are positioned asymmetrically with respect to the center axis CL in the width direction.

Furthermore, the positions of four output channels 11 coupled to the other end part 15 of the multi-mode interference coupler 13 are preferably determined corresponding to the positions where two input channels 11a and 11b are coupled to one end part 14.

Alternatively, one end input channel 11a and the other input channel 11b may be replaced with each other.

Next, the positions where four output channels 11 are coupled to the other end part 15 in the width direction will be described based on the positions where two input channels 11a and 11b are coupled to the other end part 14.

In FIG. 6A, a virtual input channel 11d is arranged on the position symmetrical to the position where one input channel 11a is coupled to the other end part 14 with respect to the center axis CL in the width direction. In addition a virtual input channel 11c is arranged on the position symmetrical to the position where the other input channel 11b is coupled to one end part 14 with respect to the center axis CL in the width direction. Similarly, virtual input channels 11c and 11d are illustrated in FIGS. 6B and 6C.

Preferably, each output channel 12 is preferably coupled to the other end part 15 in the width direction at the same intervals as those of coupling of two input channels 11a and 11b and virtual input channels 11c and 11d to one end part 14 in the width direction.

Since the input channels and the output channels are coupled to the multi-mode interference coupler 13 as described above, a signal beam, which is obtained such that an input QPSK signal beam is self-imaged by multi-mode interference in the multi-mode interference coupler 13, can be obtained from each of the output channels.

The optical hybrid circuit 10 may have optical performance that allows an input beam from any of the input channels to be equally divided into different beams and then output from the respective output channels. Further, the optical hybrid circuit 10 may have optical performance that results in a small relative phase deviation in between the phase of each signal beam output from the output channel and the phase of the input QPSK signal beam.

Specifically, in the multi-mode interference coupler 13, a QPSK signal beam is input into any of the four input channels 11 and the difference among the respective signal beams output from the four output channels 12 is set to 3 dB or less based on the optical strength of the input QPSK signal beam. Further, the difference among the respective signal beams output from four output channels 12 may be set to 2 dB or less based on the optical strength of the input QPSK signal beam. Still further, the difference among the respective signal beams output from four output channels 12 may be set to 1 dB or less based on the optical strength of the input QPSK signal beam.

In the multi-mode interference coupler 13, relative phase deviation among the signal beams output from four output channels are preferably not more than 10 degrees. Specifically, if the output signal beam is an in-phase component, the phase of the signal beam may be within the range of −10 to +10 degrees with respect to 0 or 180 degrees. In addition, if the output signal beam is an orthogonal component, the phase of the signal beam is within the range of −10 to +10 degrees with respect to 90 or 270 degrees.

Relative phase deviation among the respective signal beams output from the four output channels may be set to within the range of −5 degrees to +5 degrees. Specifically, if the output signal beam is an in-phase component, the phase of the signal beam may be within the range of −5 to +5 degrees with respect to 0 or 180 degrees. In addition, if the output signal beam is an orthogonal component, the phase of the signal beam may be within the range of −5 to +5 degrees with respect to 90 or 270 degrees.

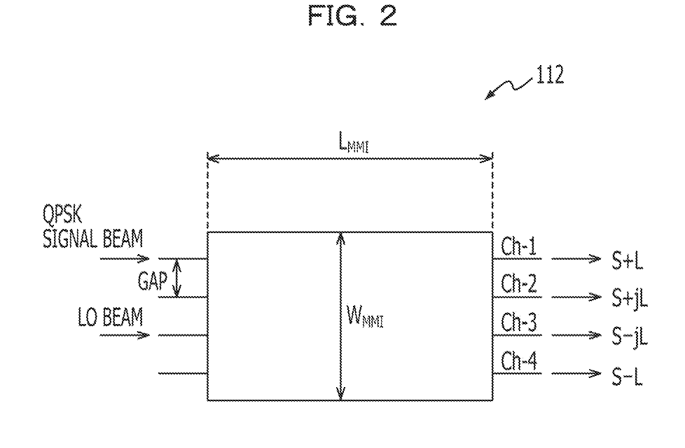

The optical hybrid circuit 10 may shorten the device length of the multi-mode interference coupler 13 while maintaining good optical properties. In the optical hybrid circuit 10, as shown in FIG. 5, the width W_{S} of one end part is smaller than the width W_{M} of the other end part. Therefore, the average width of the optical hybrid circuit is smaller than the constant width of the rectangular optical hybrid circuit shown in FIG. 2, so that the device length of the multi-mode interference coupler 13 can be shortened relative to the optical hybrid circuit having the rectangular multi-mode interference coupler shown in FIG. 2.

Next, the device length of the multi-mode interference coupler 13 of the optical hybrid circuit 10 will be described below.

First, the relationship between the optimal device length L_{MMI} of the rectangular multi-mode interference coupler shown in FIG. 2 and the width W_{MMI} of the multi-mode interference coupler will be described. Next, using the device length L_{MMI} of such a rectangular multi-mode interference coupler, the device length of the multi-mode interference coupler 13 of the optical hybrid circuit 10 will be represented.

The optimal device length L_{MMI} of the rectangular multi-mode interference coupler shown in FIG. 2 is determined depending on the width W_{MMI} of the multi-mode interference coupler, the refractive index of the waveguide, an excitation mode number, an interference mechanism, and so on. The relationship between the optimal device length L_{MMI} of the multi-mode interference coupler and the width W_{MMI} of the multi-mode interference coupler may be obtained as follows:

First, in the case of the square-shaped multi-mode interference coupler shown in FIG. 2, a propagation constant βv (v: propagation mode order) of any mode where a light beam propagates through the multi-mode interference coupler may be simplistically represented by the following equation (1):

$${β}_{v} = {k}_{0} {N}_{eq} - \frac{{( v + 1 )}^{2} πλ}{4 \cdot {N}_{eq} \cdot {W}_{MMI}^{2}} \qquad ( 1 )$$

Here, k₀ represents the wave number of a signal beam in vacuum, N_{eq} represents the refractive index of the waveguide in the multi-mode interference coupler, and λ represents the wavelength of the signal beam. In this case, the difference between the propagation constant of a basic mode and the propagation constant of any higher-order mode, which may be excited in the multi-mode interference coupler, may be represented by the following equation (2):

$${β}_{0} - {β}_{v} ≅ \frac{v ( v + 2 ) πλ}{4 {N}_{eq} {W}_{MMI}^{2}} = \frac{v ( v + 2 ) π}{2 {L}_{π}} \qquad ( 2 )$$

Here, L_{π} represents the beat length of the multi-mode interference coupler. In the case of the rectangular multi-mode interference coupler, the beat length L_{π} is approximated by equation (3) derived from equation (2).

$${L}_{π} = \frac{π}{{β}_{0} - {β}_{1}} ≅ \frac{4 \cdot {N}_{eq} \cdot {W}_{MMI}^{2}}{3 \cdot λ} \qquad ( 3 )$$

Therefore, the relationship between the optimal device length L_{MMI} of the rectangular multi-mode interference coupler shown in FIG. 2 and the width W_{MMI} of the multi-mode interference coupler may be obtained as represented by equation (3a).

$${L}_{MMI} = \frac{3}{4} {L}_{π} \qquad ( 3 a )$$

Next, using the device length L_{MMI} of such a rectangular multi-mode interference coupler, the device length L_{M} of the multi-mode interference coupler 13 of the optical hybrid circuit 10 will be obtained.

First, since the width of the multi-mode interference coupler 13 shown in FIG. 5 is not constant in the z axis direction, the difference between the propagation constant of the fundamental mode and the propagation mode of any higher-order mode varies in the z axis direction. Then, the difference between the propagation constant of the basic mode and the propagation mode of any higher-order mode is integrated over an interval from 0 to L_{M} in the z axis direction to represent the variation Δρ of the phase in the multi-mode interference coupler 13 as equation (4).

$$Δρ = {\int }_{0}^{{L}_{M}} ( {β}_{0} - {β}_{v} ) d z = \frac{v ( v + 2 ) πλ}{4 \cdot {N}_{eq}} {\int }_{0}^{{L}_{M}} \frac{d z}{{W}_{M} ( z )} \qquad ( 4 )$$

Here, W_{M}(z) represents the width of the multi-mode interference coupler 13 with the function of z. Function W_{M}(z) can be represented as equation (5) as the function of z.

$${W}_{M} ( z ) = {W}_{S} + ( {W}_{M} - {W}_{S} ) \frac{x}{{L}_{M}} \qquad ( 5 )$$

Equation (6) can be obtained by integration after substituting the equation (5) into the equation (4).

$$\begin{matrix}Δρ = 〈 {β}_{0} - {β}_{v} 〉 = \frac{v ( v + 2 ) πλ}{4 \cdot {N}_{eq} \cdot {W}_{S}^{2}} {χ}^{ST} & ( 6 ) \\ {χ}^{ST} = \frac{{W}_{M}}{{W}_{S}} & ( 7 )\end{matrix}$$

Here, χ^{ST} represented by equation (7) is a constant depending on the shape of the multi-mode interference coupler 13 and defined by W_{S} and W_{M}, which represent the widths of the opposite ends of the multi-mode interference coupler 13.

Furthermore, from the equations (3) and (6), using the beat length L_{π} of the rectangular multi-mode interference coupler, the relationship between the optimal beat length L_{STπ} and the constant χ^{ST} of the multi-mode interference coupler 10 of the optical hybrid circuit 13 shown in FIG. 5 may be obtained as represented by the following equation (8):

$${L}_{ST π} = \frac{{L}_{π}}{{χ}^{ST}} \qquad ( 8 )$$

Thus, using the beat length L_{π} of such a rectangular multi-mode interference coupler, the beat length L_{STπ} of the multi-mode interference coupler 13 of the optical hybrid circuit 10 can be represented and the desired L_{M} can be obtained.

As represented by the equation (8), if the beat length L_{π} of the rectangular multi-mode interference coupler is constant, then the beat length L_{STπ} of the multi-mode interference coupler 13 is inversely proportional to the constant χ^{ST}. Therefore, it is found that the device length L_{M} of the multi-mode interference coupler 13 shown in FIG. 5 is shortened with an increase in χ^{ST}. In other words, in the case where the optical hybrid circuit 10 is designed so that the width W_{M} of the other end part of the multi-mode interference coupler 13 is equal to the width W_{MMI} of the rectangular multi-mode interference coupler shown in FIG. 2, the device length L_{M} of the multi-mode interference coupler 13 is shortened from the device length L_{MMI} of the multi-mode interference coupler shown in FIG. 2 at a rate of 1/χ^{ST}.

As described above, the χ^{ST} may be determined by defining the widths W_{S} and W_{M} of the multi-mode interference coupler 13.

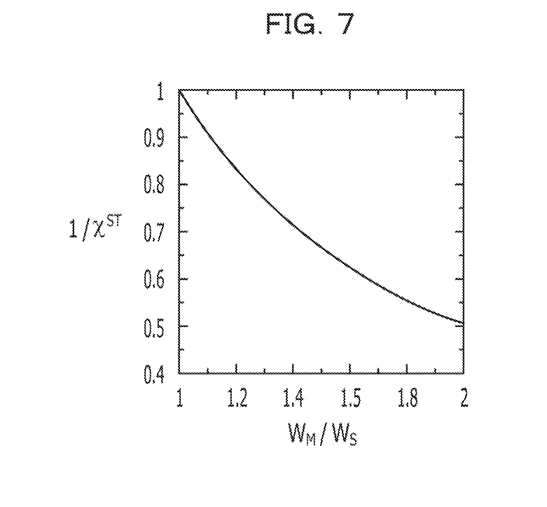

FIG. 7 is a diagram illustrating the relationship between the shortening rate and W_{M}/W_{S} of the multi-mode interference coupler 13 of the optical hybrid circuit 10.

As shown in FIG. 7, the shortening rate 1/χ^{ST} of the multi-mode interference coupler 13 varies inversely with W_{M}/W_{S}. If the value of W_{M}/W_{S} is 1 (W_{M}/W_{S}=1), then W_{M} is equal to W_{S} (W_{M}=W_{S}). In other words, the value of 1/χ^{ST}=1 is obtained because of being the same as the rectangular multi-mode interference coupler shown in FIG. 2. Then, W_{M}/W_{S} increases, while the shortening rate 1/χ^{ST} decreases. In other words, the device length of the multi-mode interference coupler 13 decreases.

Next, an exemplary computation of the optical property of the optical hybrid circuit 10 will be described below with reference to the drawings.

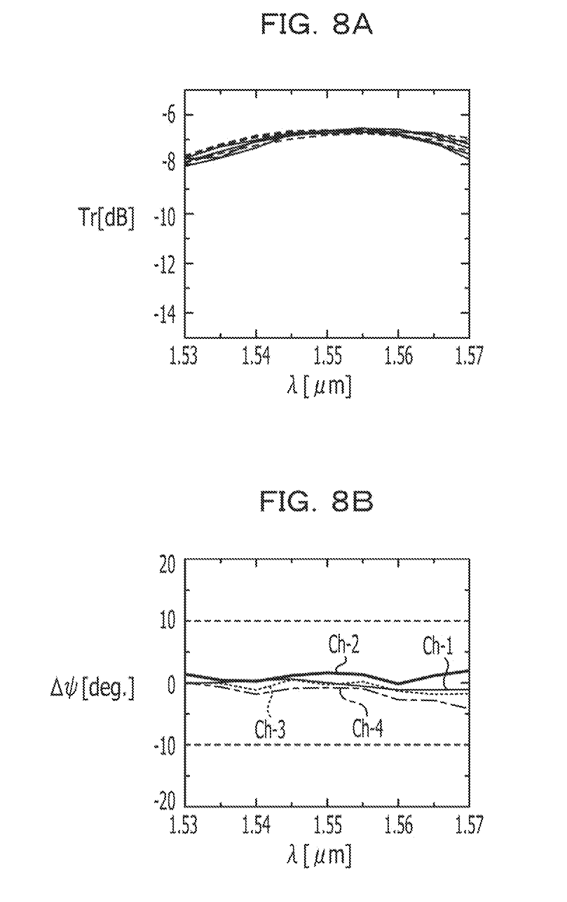

FIG. 8A is a diagram illustrating the relationship between the transmittance of each output channel and the wavelength of an input signal beam when the ratio of W_{S}/W_{M} is about 0.65. FIG. 8B is a diagram illustrating the relationship between the relative phase deviation of each output channel and the wavelength of the input signal beam when the ratio of W_{S}/W_{M} is about 0.65. That is, the device length of multi-mode interference coupler 13 of optical hybrid circuit 10 is shortened to about 65% compared with the rectangular optical hybrid circuit shown in FIG. 2.

In FIG. 8A, a signal beam is input from one input channel 11a and the result of computing the transmittance Tr of an output signal beam from each of four output channels with respect to the wavelength λ of the input signal beam is represented by a solid line. In addition, in FIG. 8A, a signal beam is input from the other input channel 11b and the result of computing the transmittance Tr of an output signal beam from each of four output channels with respect to the wavelength λ of the input signal beam is represented by a chain line. In other words, in FIG. 8A, the transmittance Tr is represented by four solid lines and four chain lines. The transmittance Tr represents the relative light intensity of each of signal beams output from four output channels 12 by the unit of “dB” based on the light intensity of the input QPSK signal beam.

In FIG. 8B, furthermore, a QPSK signal beam is input into one input channel 11a and an LO beam is input into the other input channel 11b and the result of the relative phase deviation Δψ for each output channel with respect to the wavelength λ of the input signal beam is then represented. In addition, if the output signal beam is an in-phase component, then the difference between the phase of the signal beam and 0 or 180 degrees means the phase shift Δψ. In addition, if the output signal beam is an orthogonal component, then the difference between the phase of the signal beam and 90 or 270 degrees means the phase shift Δψ. Furthermore, in FIG. 8B, an operation band is represented at a relative phase deviation of ±10 degrees.

The results shown in FIGS. 8A and 8B were calculated using a beam propagation method (BPM). In the calculation by the BPM, the equivalent refractive index of the waveguide region of the multi-mode interference coupler was 3.24 and the refractive index of any region other than the waveguide was 1.0. Furthermore, the size of each component that made up the optical hybrid circuit 10 was as follows: The width of each of input channels 11 and output channels 12 was 2.0 μm and the distance (gap) between the input channels was 2.3 μm. In addition, the width W_{S} was 11.2 μm and the width W_{M} was 17.2 μm.

As shown in FIG. 8A and FIG. 8B, the optical hybrid circuit 10 represents good optical power balance and small relative phase deviation over a wide range of wavelengths. In other words, the input signal beam is equally divided into four output channels and signal beams with small phase shift are then output therefrom, respectively. In other words, it is found that the optical hybrid circuit 10 has good optical performance in the C band region.

Next, the optical property of the optical hybrid circuit 10 when the device length of the multi-mode interference coupler 13 of the optical hybrid circuit 10 is further shortened will be described below with reference to the drawings.

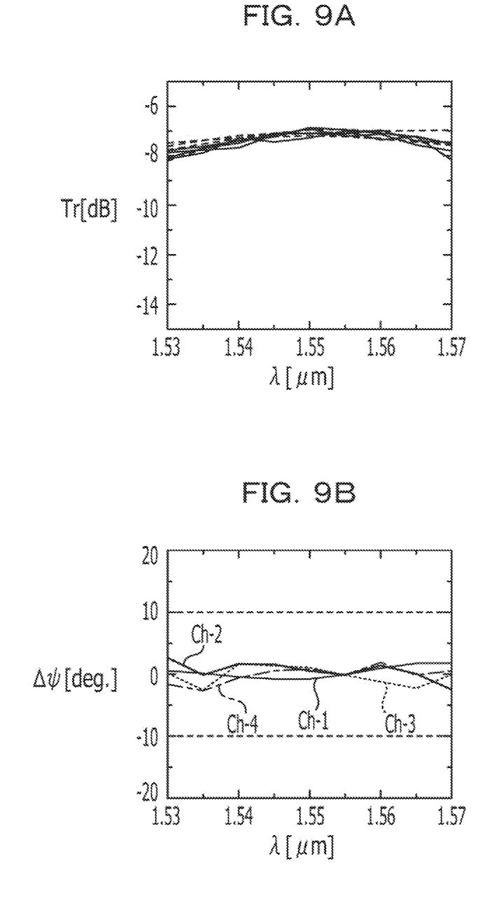

FIG. 9A is a diagram illustrating the relationship between the transmittance of each output channel and the wavelength of an input signal beam when the ratio of W_{S}/W_{M} is about 0.53. FIG. 9B is a diagram illustrating the relationship between the relative phase deviation of each output channel and the wavelength of the input signal beam when the ratio of W_{S}/W_{M} is about 0.53. That is, the device length of multi-mode interference coupler 13 of optical hybrid circuit 10 is shortened to about 53% compared with the rectangular optical hybrid circuit shown in FIG. 2.

Furthermore, the size of each component that made up the optical hybrid circuit 10 was as follows: The width of each of input channels 11 and output channels 12 was 2.0 μm and the distance (gap) between the input channels was 2.3 μm. In addition, the width W_{S} was 9.2 μm and the width W_{M} was 17.2 μm. Calculation in each of FIG. 9A and FIG. 9B was performed using the BPM in a manner similar to each of FIG. 8A and FIG. 8B, except that the width W_{S} was 9.2 μm.

As shown in FIG. 9A and FIG. 9B, even though the device length of multi-mode interference coupler 13 of the optical hybrid circuit 10 is shortened to about 53% compared with the rectangular optical hybrid circuit shown in FIG. 2, the optical hybrid circuit 10 represents good optical power balance and small relative phase deviation over a wide range of wavelengths.

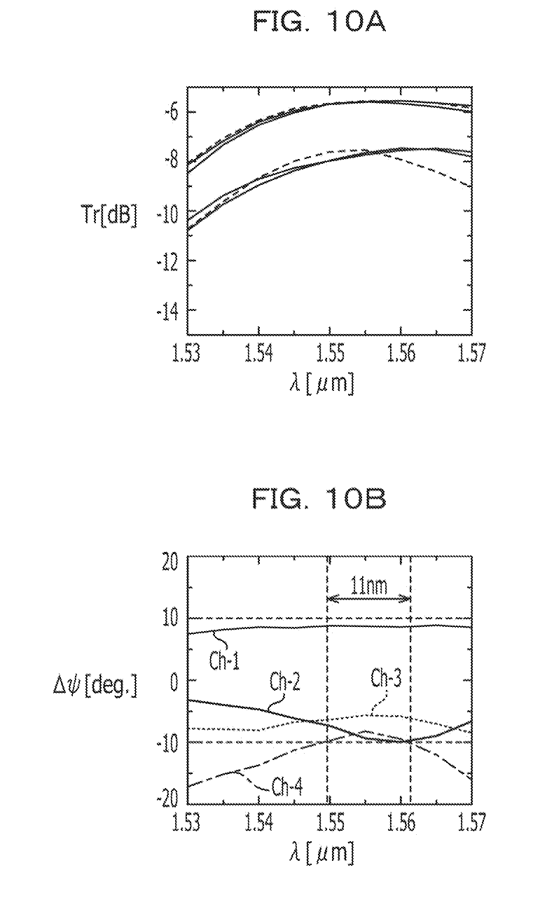

FIG. 10A is a diagram illustrating the relationship between the transmittance of each output channel of the conventional optical hybrid circuit shown in FIG. 3 and the wavelength of an input signal beam. FIG. 10B is a diagram illustrating the relationship between the relative phase deviation of each output channel and the wavelength of an input signal beam.

In FIG. 10A and FIG. 10B, the size of each component that made up the optical hybrid circuit was as follows: The width of each of input channels 11 and output channels 12 was 2.0 μm, the distance between the input channel 11 and the output channel 12 was 2.3 μm, the width W_{MMI} was 17.2 μm, and the width W_{MB} was 13.2 μm. The shortening rate of the device length was 75%.

As shown in FIG. 10A, the optical hybrid circuit shown in FIG. 3 has significant optical power imbalance for each output channel and an input signal beam is not equally divided. Furthermore, as shown in FIG. 10B, it is found that the range of the relative phase deviation within ±10 degrees (11 nm) becomes sharply narrow. In other words, the optical hybrid circuit illustrated in FIG. 3 represents a significant decrease in optical property when the device length of the multi-mode interference coupler is shortened.

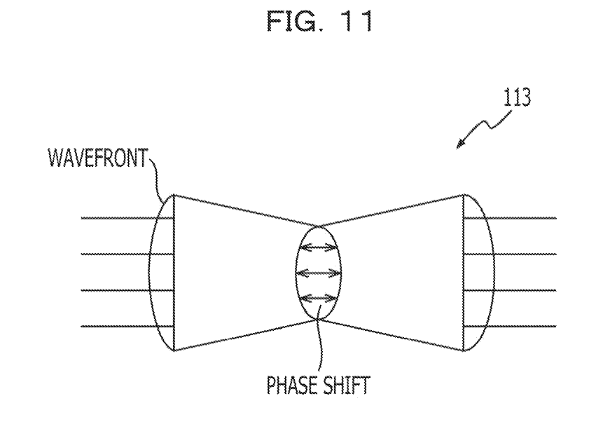

FIG. 11 is a diagram illustrating a wavefront propagating in the optical hybrid circuit shown in FIG. 3.

In the optical hybrid circuit 113 shown in FIG. 3 as illustrated in FIG. 11, the wavefront of a signal beam input from the input channel to the multi-mode interference coupler propagates the inside of the multi-mode interference coupler while curving concentrically. In this case, the butterfly-shaped MMI coupler with discontinuous taper variation causes excess phase delays based on the curved wavefront within the multi-mode interference region. Therefore, the optical hybrid circuit 113 shown in FIG. 3 exerts optical properties as shown in FIG. 10A and FIG. 10B.

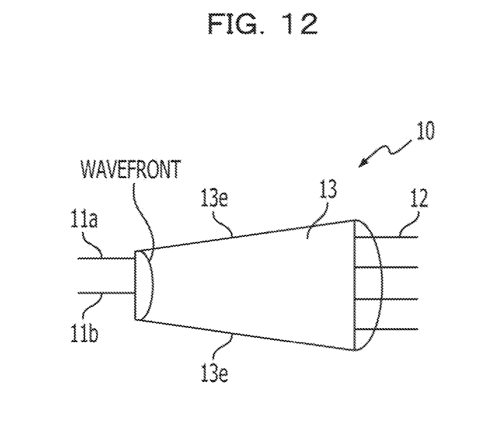

FIG. 12 is a diagram illustrating a wavefront propagating in the optical hybrid circuit of the present embodiment shown in FIG. 5.

In the optical hybrid circuit 10 shown in FIG. 5, as illustrated in FIG. 12, the wavefront of a signal beam input from the input channel into the multi-mode interference coupler propagates the inside of the multi-mode interference coupler while curving concentrically. The distance of the outermost side parts 13e of the multi-mode interference coupler 13 (i.e., the width of the multi-mode interference coupler 13) linearly increases from the side of the input channels 11a and 11b to the side of the output channels 12 along the propagation direction of the multi-mode interference coupler 13 without causing any decrease in distance. In this case, since the MMI width variation keeps constant one-way taper shape, the wavefront within the MMI region stays constant along the propagation direction. Therefore, the optical hybrid circuit 10 shown in FIG. 5 has good optical properties as shown in FIG. 8A to FIG. 9B. Thus, for example, good optical performance may be obtained in the C band region.

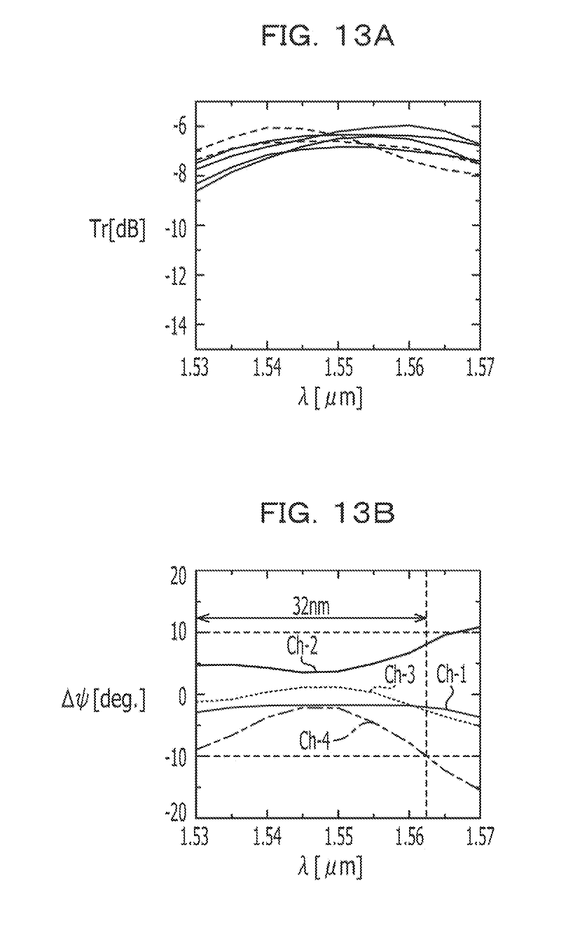

FIG. 13A is a diagram illustrating the relationship between the transmittance of each output channel of the conventional optical hybrid circuit shown in FIG. 4 and the wavelength of an input signal beam. FIG. 13B is a diagram illustrating the relationship between the relative phase deviation of each output channel and the wavelength of an input signal beam.

In FIG. 13A and FIG. 13B, the size of each component that made up the optical hybrid circuit 10 was as follows: The width of each of input channels 11 and output channels 12 was 2.0 μm, the distance between the input channel 11 and the output channel 12 was 2.3 μm, the width W_{S} was 17.2 μm, and the width W_{M} was 13.2 μm. The shortening rate of the device length was about 70%.

As shown in FIG. 13A, the optical hybrid circuit shown in FIG. 4 has good optical power balance over a wide range of wavelengths. However, as shown in FIG. 13B, it is found that the range (32 nm) in which the relative phase deviation falls in ±10 degrees can be extensively narrowed.

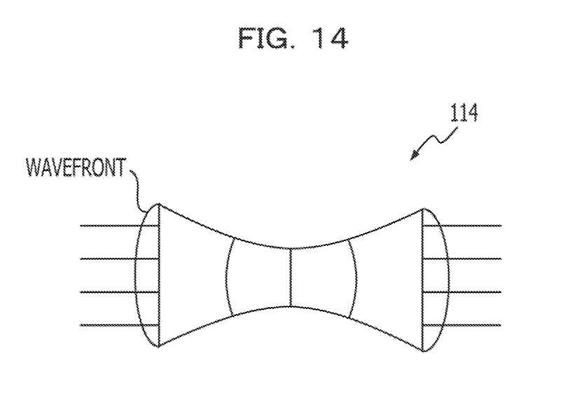

FIG. 14 is a diagram illustrating a wavefront propagating in the optical hybrid circuit shown in FIG. 4. In the optical hybrid circuit 114 shown in FIG. 4, unlike the case illustrated in FIG. 11, the excess phase delays at the mid-plane of the tapered MMI region can be compensated for by parabolically tapering the MMI coupler. But since the compensation of the wavefront curving tents to be wavelength sensitive, the optical hybrid circuit 114 shown in FIG. 4 has a large relative phase deviation as shown in FIG. 13B. Thus, for example, good optical performance cannot be obtained in the C band region.

Next, the optical property of the optical hybrid circuit 10 shown in FIG. 5 when the distance (gap) between the output channels is shortened will be described below with reference to the drawings.

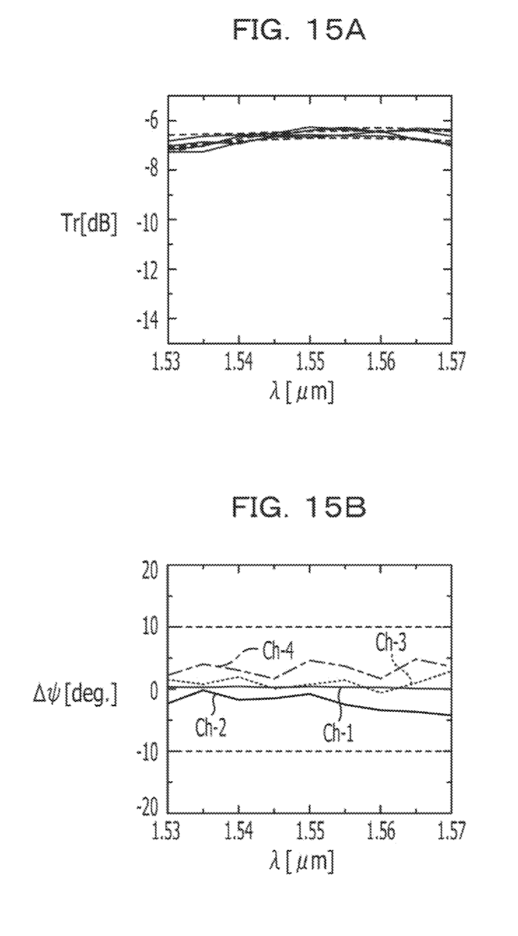

FIG. 15A is a diagram illustrating the relationship between the transmittance of each output channel of the optical hybrid circuit shown in FIG. 5 and the wavelength of an input signal beam when the distance (gap) between the output channels of this optical hybrid circuit is 1.0 μm (i.e., gap=1.0 μm). FIG. 10B is a diagram illustrating the relationship between the relative phase deviation of each output channel and the wavelength of an input signal beam.

Furthermore, the size of each component that made up the optical hybrid circuit 10 was as follows: The width of each of input and output channels 11 and 12 was 2.0 μm, the distance (gap) between the output channels was 1.0 μm, the width W_{S} was 8.0 μm, and the width W_{M} was 12.0 μm. Since the distance (gap) between the output channels was 1.0 μm, the distance (gap) is one half or less of the gap of 2.3 μm employed in each of FIG. 8A to FIG. 9A. Calculation in each of FIG. 15A and FIG. 15B was performed using BPM in a manner similar to each of FIG. 8A and FIG. 8B, except of differences in dimensions of the respective components. Furthermore, W_{S}/W_{M} was about 0.66 and the shortening rate of the device length was about 66%. Specifically, the device length of the multi-mode interference coupler 13 was 198 μm.

As shown in FIG. 15A and FIG. 15B, the optical hybrid circuit 10 represents good optical power balance and small relative phase deviation over a wide range of wavelengths. In other words, the optical hybrid circuit 10 has the distance (gap) between the output channels as short as 1.0 μm. Thus, even if the device length of multi-mode interference coupler 13 of the optical hybrid circuit 10 is shortened to about 66% compared with the rectangular optical hybrid circuit shown in FIG. 2, it shows good optical property.

Next, the optical properties of the optical hybrid circuit 10 where the distance (gap) between the output channels is 1.0 μm will be described relative to those of the conventional rectangular optical hybrid circuit with a shortened distance between the output channels as shown in FIG. 2.

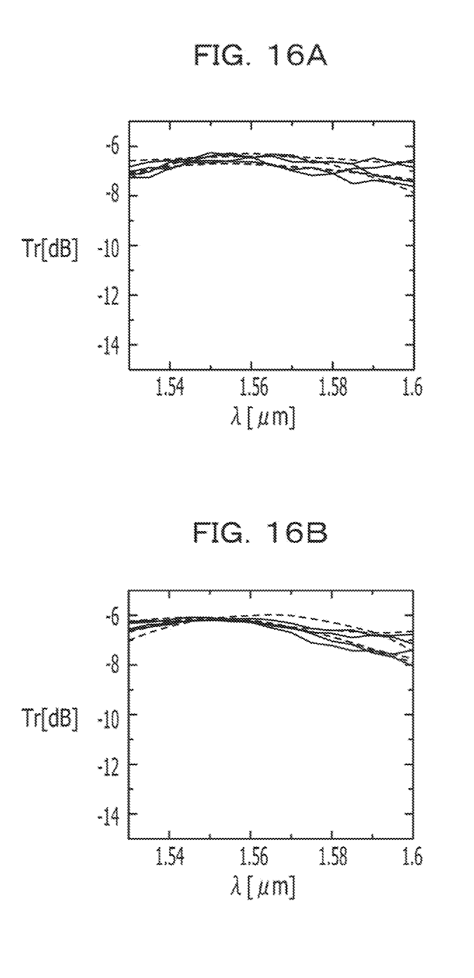

FIG. 16A is a diagram illustrating the relationship between the transmittance of each output channel of the optical hybrid circuit shown in FIG. 5 and the wavelength of an input signal beam when the distance (gap) between the output channels of this optical hybrid circuit is 1.0 μm (i.e., gap=1.0 μm). FIG. 16B is a diagram illustrating the relationship between the transmittance of each output channel of the optical hybrid circuit shown in FIG. 2 and the wavelength of an input signal beam when the distance (gap) between the output channels of this optical hybrid circuit is 0.6 μm (i.e., gap=0.6 μm).

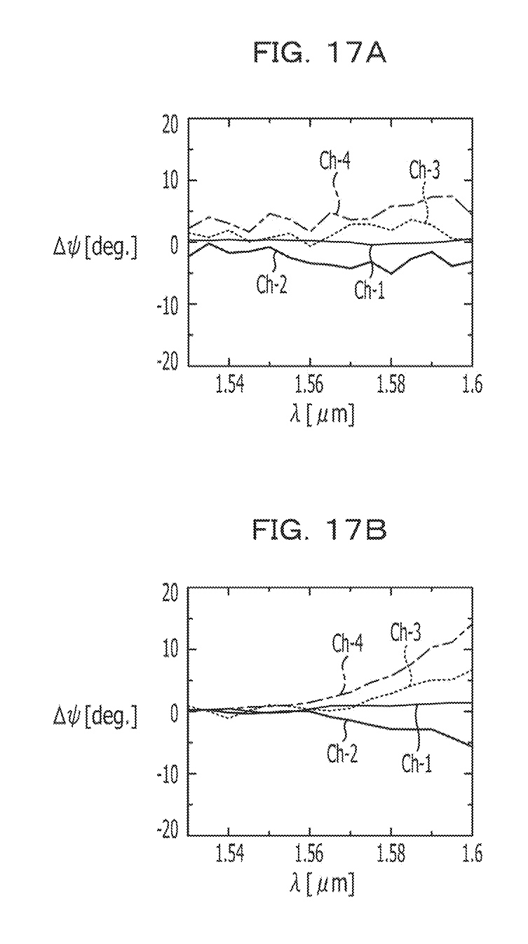

FIG. 17A is a diagram illustrating the relationship between the relative phase deviation of each output channel of the optical hybrid circuit shown in FIG. 5 and the wavelength of an input signal beam when the distance (gap) between the output channels of this optical hybrid circuit is 1.0 μm (i.e., gap=1.0 μm). FIG. 17B is a diagram illustrating the relationship between the relative phase deviation of each output channel of the optical hybrid circuit shown in FIG. 2 and the wavelength of an input signal beam when the distance (gap) between the output channels of this optical hybrid circuit is 0.6 μm (i.e., gap=0.6 μm).

Calculation results in FIG. 16A and FIG. 17A were obtained in a manner similar to FIG. 15A and FIG. 15B, except of differences in range of the horizontal axis.

Calculation in each of FIG. 16B and FIG. 17B was performed using BPM on the optical hybrid circuit shown in FIG. 2. Furthermore, the size of each component that made up the optical hybrid circuit was as follows: The width of each of input and output channels was 2.0 μm, the distance between the input channel and the output channel was 0.6 μm, and the width W_{MMI} was 10.4 μm. The device length of the multi-mode interference coupler was 223 μm.

Furthermore, as shown in FIG. 16B, the rectangular optical hybrid circuit shown in FIG. 2 has good optical power balance over a wide range of wavelengths like the optical hybrid circuit 10 of the present embodiment shown in FIG. 5.

However, as shown in FIG. 17B, in the rectangular optical hybrid circuit shown in FIG. 2, it is found that the wavelength range in which the relative phase deviation falls in ±10 degrees can be narrowed.

On the other hand, the optical hybrid circuit 10 shown in FIG. 5 can shorten the device length of the multi-mode interference coupler 13 even when the distance (gap) between the output channels becomes short.

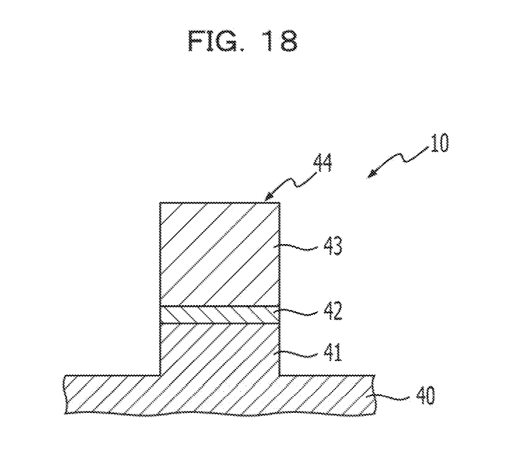

FIG. 18 is an enlarged cross-sectional diagram along the line X-X of FIG. 5.

The optical hybrid circuit 10 is formed such that a lower cladding layer 41 is disposed on a substrate 40, a core layer 42 is disposed on the lower cladding layer 41, and an upper cladding layer 43 is disposed on the core layer 43. A mesa part 44 is constructed of the lower cladding layer 41, the core layer 42, and the cladding layer 42. Here, the lower cladding layer 41 and the substrate 40 are integrally formed in the optical hybrid circuit 10.

The cross-sectional view shown in FIG. 18 is that of the second part 13b of the multi-mode interference coupler 13. It is noted that each of the input channels 11 and the output channels 12 have a similar cross-sectional structure. In other words, the thickness of each of the lower cladding layer 41, the core layer 42, and the upper cladding layer 43 is constant over the entire optical hybrid circuit 10 including the multi-mode interference coupler 13.

For example, the optical hybrid circuit 10 shown in FIG. 18 may be formed as follows.

First, for example, the core layer 41 is disposed on the substrate 40 by metal-organic vapor phase epitaxy (MOVPE method). The substrate 40 may be an n-type InP substrate or an undoped InP substrate. As a forming material of the core layer 42, undoped GaInAsP (an emission wavelength of 1.30 μm) may be used. For example, the core layer 42 may have a thickness of 0.3 μm.

Next, the upper cladding layer 43 is epitaxially deposited on the core layer 42. As a forming material of the upper cladding layer 43, undoped or p-type InP can be used. For example, the upper cladding layer 43 may have a thickness of 2.0 μm.

Next, a mask layer, such as a SiO2 film, is formed on the upper cladding layer 43.

Next, a photolithography process is used for patterning an area for forming an optical hybrid circuit in the mask layer.

Then, the mask layer is used as a mask to etch the upper cladding layer 43, the core layer 42, and the substrate 40, thereby forming the mesa part 44. As shown in FIG. 16, the substrate is etched from the surface of the substrate partway through the substrate 40 to form a convex lower cladding layer 41. As an etching method, for example, dry etching, such as inductively coupled plasma (ICP) reactive ion etching may be used. In addition, for example, the mesa part 44 may have a height of 3.0 μm.

Subsequently, the optical hybrid circuit 10 is formed by removing the mask layer from the upper cladding layer 43.

Here, the above exemplified method for forming the optical hybrid circuit 10 has been described as one using InP, which is a III-V group compound semiconductor, as a forming material. However, the forming material is not limited to any of these material systems. Alternatively, for example, the optical hybrid circuit may be formed using GaAs (III-V group compound semiconductor), Si (IV group semiconductor), or the like.

The optical hybrid circuit 10 of the aforementioned present embodiment has small dimensions and is excellent in optical performance.

In addition, the optical hybrid circuit 10 of the present embodiment is suitable for monolithic integration. As described above, the device length of the multi-mode interference coupler 13 of the optical hybrid circuit 10 may be shortened at least about 50% while maintaining good optical properties.

Furthermore, in the optical hybrid circuit 10, the device length of the multi-mode interference coupler can be shortened without reducing the distance between the input channels and the distance between the output channels. Therefore, the optical hybrid circuit 10 can be formed using a manufacturing process with conventional processing accuracy.

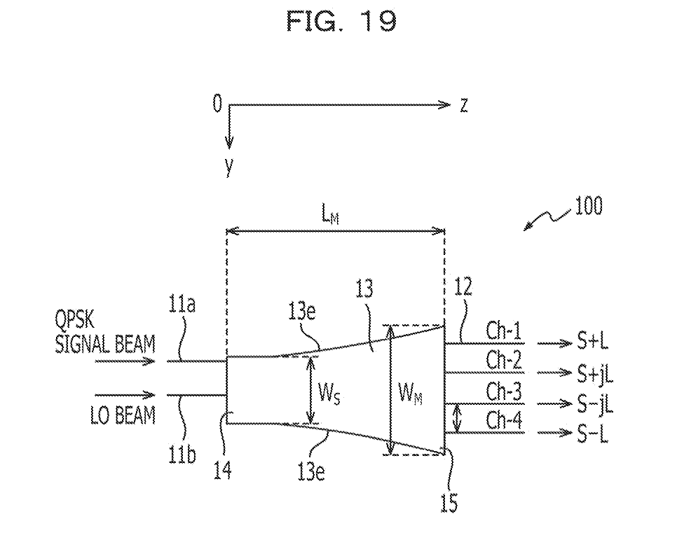

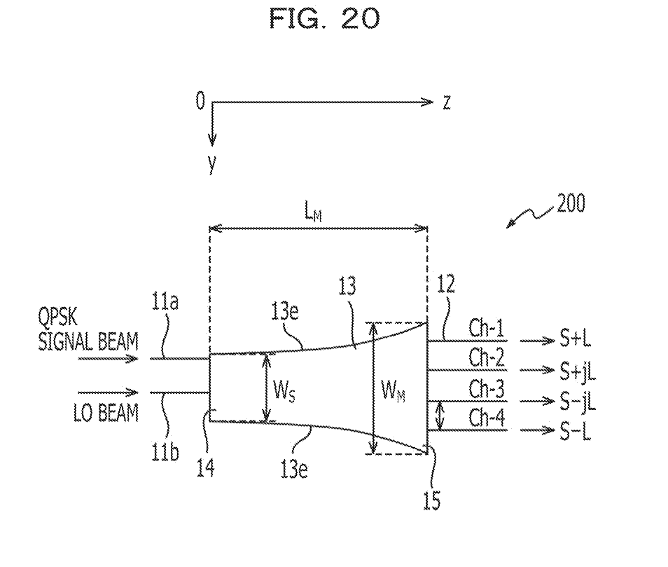

Next, an optical hybrid circuit as an example of the optical waveguide device according to each of second and third preferred embodiments disclosed in the present specification will be described with reference to the attached drawing. To any point which is not specifically described for the second and third embodiments, the detailed description about the aforementioned first embodiment will be suitably applied. In FIG. 19 and FIG. 20, the same structural elements as those in FIG. 5 are designated by the same reference numerals.

FIG. 19 is a diagram illustrating an optical hybrid circuit according to the second embodiment disclosed in the present specification.

The optical hybrid circuit 100 of the present embodiment includes a pair of side parts 13e and each of the side parts 13e is in a parabolic shape inwardly. Other structures of the optical hybrid circuit 100 are the same as those of the first embodiment described above.

Next, using the device length L_{MMI} of the rectangular multi-mode interference coupler shown in FIG. 2, the device length of the multi-mode interference coupler 13 of the optical hybrid circuit 100 shown in FIG. 19 will be obtained as described below.

Function W_{M}(z) in the above equation (4) can be represented as equation (9) as the function of z.

$${W}_{M} ( z ) = {W}_{S} + ( {W}_{M} - {W}_{S} ) \cdot {( \frac{z}{{L}_{M}} )}^{2} \qquad ( 9 )$$

Equation (10) can be obtained by integration after substituting the equation (9) into the equation (4).

$$\begin{matrix}Δρ = 〈 {β}_{0} - {β}_{v} 〉 = \frac{v ( v + 2 ) πλ}{4 {N}_{eq} {W}_{M}^{2}} {χ}^{SQ} & ( 10 ) \\ {χ}^{SQ} = \frac{{W}_{M}}{2} ( \frac{1}{{W}_{S}} + \frac{{W}_{M} {tanh}^{- 1} [ \sqrt{\frac{{W}_{S} - {W}_{M}}{{W}_{S}}} ]}{{W}_{S} \sqrt{{W}_{S}} \sqrt{{W}_{S} - {W}_{M}}} ) & ( 11 )\end{matrix}$$

Here, χ^{SQ} represented by equation (10) is a constant depending on the shape of the multi-mode interference coupler 13 and defined by W_{S} and W_{M}, which represent the widths of the outermost ends of the multi-mode interference coupler 13.

Furthermore, from the equations (3) and (10), using the beat length L_{π} of the rectangular multi-mode interference coupler, the relationship between the optimal beat length L_{SQπ} and the constant χ^{SQ} of the multi-mode interference coupler 13 of the optical hybrid circuit 10 shown in FIG. 19 can be obtained as represented by the following equation (12):

$${L}_{SQ π} = \frac{{L}_{π}}{{χ}^{SQ}} \qquad ( 12 )$$

Thus, using the beat length L_{π} of such a rectangular multi-mode interference coupler, the beat length L_{SQπ} of the multi-mode interference coupler 13 of the optical hybrid circuit 100 can be represented.

As represented by the equation (12), if the beat length L_{π} of the rectangular multi-mode interference coupler is constant, then the beat length L_{SQπ} of the multi-mode interference coupler 13 is inversely proportional to the constant χ^{SQ}.

FIG. 20 is a diagram illustrating an optical hybrid circuit according to the third embodiment disclosed in the present specification.

The optical hybrid circuit 200 of the present embodiment includes a pair of side parts 13e and the profile of each of the side part 13e is inwardly curved like an exponential graph. Other structures of the optical hybrid circuit 200 are the same as those of the first embodiment described above. Although any positive real number may be used as the base of the exponential function, in this case, the Napier's constant is used as the base of the exponential function.

Next, using the beat length L_{π} of the rectangular multi-mode interference coupler shown in FIG. 2, the beat length of the multi-mode interference coupler 13 of the optical hybrid circuit 200 shown in FIG. 20 will be obtained as described below.

Function W_{M}(z) in the above equation (4) may be represented as equation (13) as the function of z.

$${W}_{M} ( z ) = {W}_{S} + ( {W}_{M} - {W}_{S} ) \cdot ( \frac{Exp ( z / {L}_{M} ) - 1}{e - 1} ) \qquad ( 13 )$$

Equation (14) may be obtained by integration after substituting the equation (13) into the equation (4).

$$\begin{matrix}Δρ = 〈 {β}_{0} - {β}_{v} 〉 = \frac{v ( v + 2 ) πλ}{4 {N}_{eq} {W}_{M}^{2}} {χ}^{EXP} & ( 14 ) \\ {χ}^{EXP} = \frac{( e - 1 ) {W}_{M} ( \begin{matrix}{W}_{M}^{2} - 2 {W}_{S} {W}_{M} + e \cdot {W}_{S}^{2} - \\ ( e - 1 ) {W}_{S} {W}_{M} log ( {W}_{M} / {W}_{S} )\end{matrix} )}{{{W}_{S} ( {W}_{M} - e \cdot {W}_{S} )}^{2}} & ( 15 )\end{matrix}$$

Here, χ^{EXP} represented by equation (15) is a constant depending on the shape of the multi-mode interference coupler 13 and defined by W_{S} and W_{M}, which represent the widths of the outermost ends of the multi-mode interference coupler 13.

Furthermore, from the equations (3) and (14), using the beat length L_{π} of the rectangular multi-mode interference coupler, the relationship between the optimal beat length L_{EXPπ} and the constant χ^{EXP} of the multi-mode interference coupler of the optical hybrid circuit 200 shown in FIG. 20 may be obtained as described in the following equation (16):

$${L}_{EXP π} = \frac{{L}_{π}}{{χ}^{EXP}} \qquad ( 16 )$$

Thus, using the beat length L_{π} of such a rectangular multi-mode interference coupler, the beat length L_{EXPπ} of the multi-mode interference coupler 13 of the optical hybrid circuit 200 can be represented.

As represented by equation (16), if the beat length L_{π} of the rectangular multi-mode interference coupler is constant, then the beat length L_{EXPπ} of the multi-mode interference coupler 13 is inversely proportional to the constant χ^{EXP}.

Next, the shortening rates of the device lengths of the respective optical hybrid circuits of the aforementioned first to third embodiments will be compared and described below.

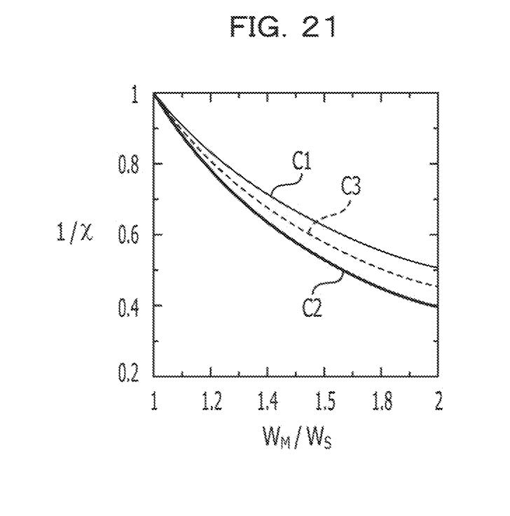

FIG. 21 is a diagram illustrating the relationship between the shortening rate Re of the optical hybrid circuit of each of the first to third embodiments and the W_{M}/W_{S} thereof.

In FIG. 21, the shortening rate Re of the first embodiment is represented by curve C1. This curve 1 can be represented using equation (7). In addition, the shortening rate of the second embodiment is represented by curve C2 and this curve C2 can be expressed using equation (11). The shortening rate of the third embodiment is represented by curve C3 and this curve C3 can be expressed using equation (15).

As shown in FIG. 21, any of these embodiments can reduce the shortening rate Re while causing an increase in W_{M}/W_{S}. If the values of W_{M}/W_{S} in these embodiments are equal to one another, the shortening rates 1/χ is are small in order of C1, C2, and C3.

Next, an optical waveguide device equipped with the aforementioned optical hybrid circuit disclosed herein will be described with reference to the attached drawings.

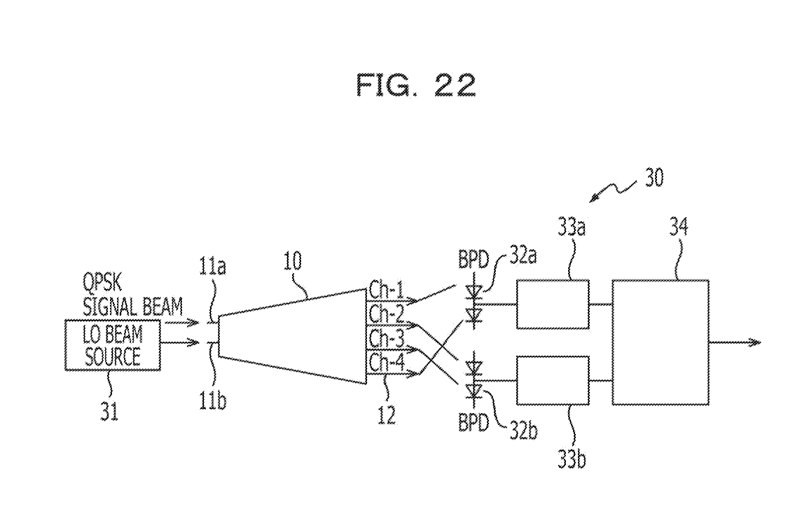

FIG. 22 is a diagram illustrating a coherent optical receiver disclosed herein.

A coherent optical receiver 30 is provided with the optical hybrid circuit 10 of the first embodiment as described above.

The coherent optical receiver 30 includes: an LO beam source 31 as a local oscillation beam generator that generates an LO beam and then outputs the LO beam to the optical hybrid circuit 10; and photoelectric converters 32a and 32b that convert each output optical signal from the optical hybrid circuit 10 into an electric signal. Specifically, balanced photo diodes (BPDs) are used as the photoelectric converters 32a and 32b. Two photodiodes in the BPD 32a receive in-phase component output signals as inputs from the optical hybrid circuit 10, respectively. In contrast, two photodiodes in the BPD 32b receive quadrature component output signals as inputs from the optical hybrid circuit 10, respectively.

The coherent optical receiver 30 further includes: AD converters 33a and 33b that receive respective analog electrical signals output from the photoelectric converters 32a and 32b and then output digital electrical signals; a digital arithmetic circuit 34 as a phase estimation unit that receive the digital electrical signals as inputs and then estimates the phase thereof.

The use of a monolithic integrated circuit as the optical hybrid circuit 10 is preferable for minimizing the coherent optical receiver 30.

Next, the operation of the coherent optical receiver 30 will be described below.

First, a QPSK signal beam and an LO beam synchronized with this QPSK signal beam are input to the input channels 11 of the optical hybrid circuit 10. In the optical hybrid circuit 10, these signal beams are self-imaged as a result of multi-mode interference and then output from four output channels 12, respectively, according to the relative phase difference Δφ between the LO beam and the QPSK signal beam.

For example, in the case of (a) Δφ=0, (b) Δφ=π, (c) Δφ=−π/2, and (d) Δφ=π/2, the ratio of the transparencies of four output beams at the relative phase difference Δφ is (a) 1:0:2:1, (b) 1:2:0:1, (c) 0:1:1:2, and (d) 2:1:1:0, respectively.

Then, the signal beams from the respective output channels are input to the BPDs 32a and 32b, respectively.

Each of the BPDs 32a and 32b outputs current equivalent to +1 with respect to the input to the upper photodiode and outputs current equivalent to −1 with respect to the input to the lower photodiode. If both the upper and lower photodiodes simultaneously receive the respective inputs, there is no output current generated. Thus, the BPDs 32a and 32b convert output signal beams into electrical signals and then output the electrical signals to the AD converters 33a and 33b, respectively.

Subsequently, the AD converters 33a and 33b that has received the inputs of analog electrical signals output from the BPDs 32a and 32b convert the analog electrical signals into digital electrical signals, respectively, followed by outputting them to the digital arithmetic circuit 34.

The digital arithmetic circuit 34 estimates a phase in response to input of the digital electrical signal and then outputs the estimated phase. Therefore, the coherent receiver 30 can demodulate the input QPSK signal beam.

Thus, the coherent receiver 30 of the aforementioned present embodiment has small dimensions and is excellent in optical performance.

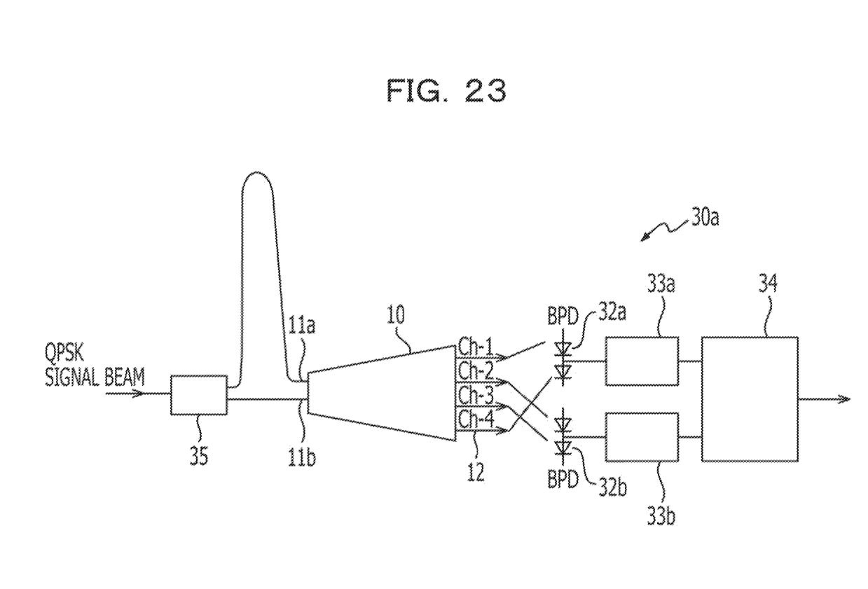

FIG. 23 is a diagram illustrating an optical receiver according to another embodiment disclosed herein.

The coherent optical receiver 30a of this embodiment receives a DQPSK signal beam as an input.

Specifically, the coherent optical receiver 30a includes a 1:2 MMI coupler 35 that receives a DQPSK signal beam as an input and then outputs the signal beam after dividing it into two. Two output signal beams from the 1:2 MMI coupler 35 passes through two waveguides 36a and 36b and then enters the optical hybrid circuit 10. Here, the optical path length of the waveguide 36a is longer than the optical path length of the waveguide 36b by one bit of the DQPSK signal beam.

Two DQPSK signal beams input into the optical hybrid circuit 10 have their respective phases which are different from each other by one bit. Thus, the signal beams are self-imaged by multi-mode interference and then output from four output channels 12, respectively. Other operations of the coherent optical receiver 30a are the same as those described in the above embodiments.

In the present invention, the optical hybrid circuit according to any of the above embodiment and the optical receiver equipped with such an optical hybrid circuit may be suitably modified unless departing from the gist of the present invention. Any requirement in one of the above embodiments or variations thereof may be suitably replaced with any of other requirements in other embodiments or variations thereof. For example, when considering direct detection, the number of output channels is set to two for input of DBPSK signal beams. In addition, the number of output channels is set to eight for input of 8 DPSK signal beams.

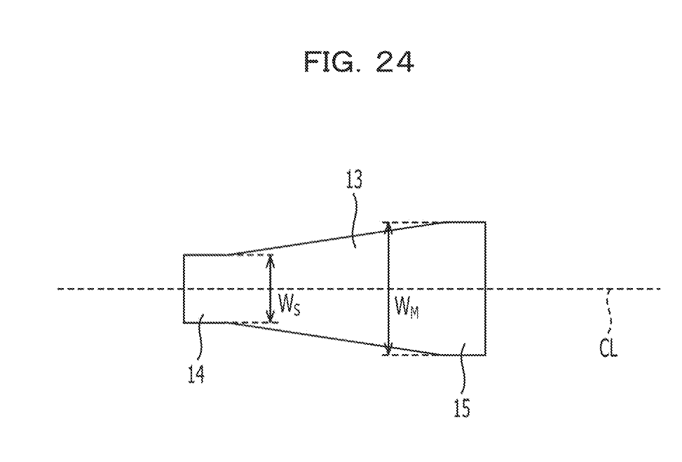

Furthermore, as shown in FIG. 24, the multi-mode interference coupler 13 in the above optical hybrid circuit extends outwardly while maintaining the width W_{S} of one end part 14 constant. Alternatively, it may extend outwardly while maintaining the width W_{M} of the other end part 15 constant.

Hereinafter, the operation effects of the optical hybrid circuit disclosed herein will be further described using examples thereof. However, the present invention is not restricted to any of these examples.

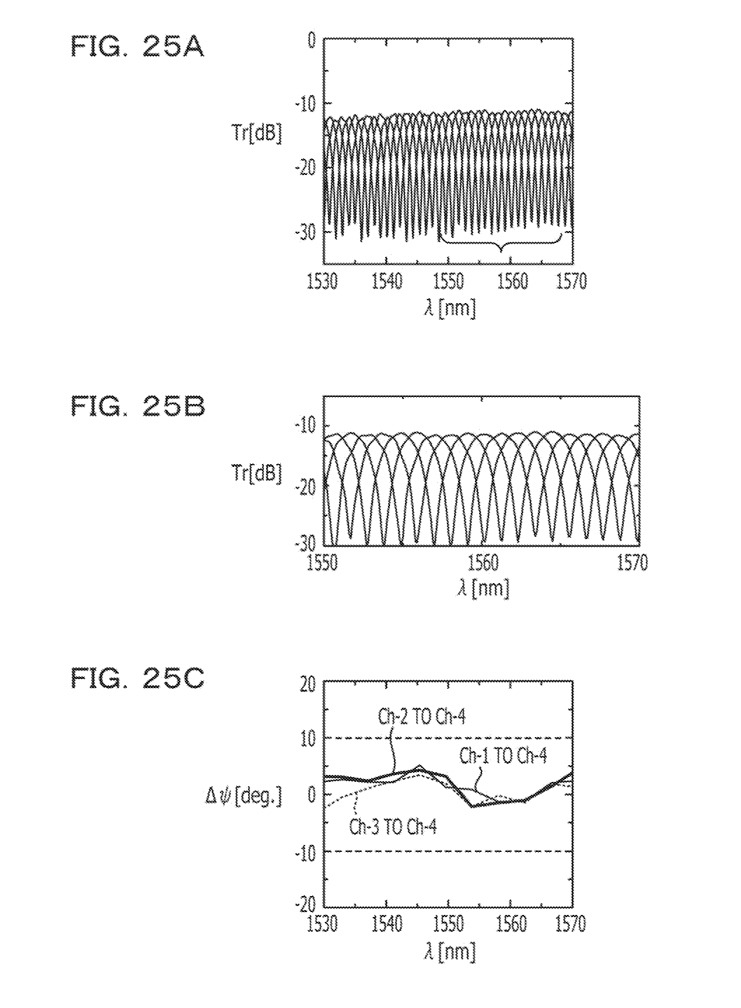

As a first example, an optical hybrid circuit having the structure illustrated in FIG. 18 as formed. As a forming material of a core layer, undoped GaInAsP (refractive index of 3.388) was used. The forming material of each of the upper and lower cladding layers used was p-type InP (refractive index of 3.169). Furthermore, the size of each component that made up the optical hybrid circuit was as follows: The width of each of input channels 11 and output channels 12 was 2.0 μm, the distance (gap) between the input channels was 2.3 μm, the width W_{S} was 9.2 μm, and the width W_{M} was 17.2 μm. That is, the same dimensions as those in the calculation examples shown in FIG. 9A and FIG. 9B were employed. It should be noted that in case of the tested device shown in FIG. 25A, FIG. 25B and FIG. 25C, the delayed interferometer was directly coupled to the two input channels of the optical hybrid circuit.

Continuous-wave (CW) light was input as an input beam into the input channel.

FIG. 25A is a diagram illustrating the transmittance of each output channel of the optical hybrid circuit of the first example and the wavelength of an input signal beam. FIG. 25B is a partially enlarged diagram of FIG. 25A. FIG. 25C is a diagram illustrating the relationship between the relative phase deviation of each output channel and the wavelength of the input signal beam.

As shown in FIGS. 25A and 25B, the optical hybrid circuit of the first embodiment represented good optical power balance of signal-beam dividing and showed optical properties which were well coincident with the calculation results shown in FIG. 9A in a qualitative manner.

Furthermore, as shown in FIG. 25B, the optical hybrid circuit of the first embodiment outputs signal beams from the respective output channels and these output signal beams are phase shifted from one another by π/2 [rad], resulting in the quadrature phase relation.

As shown in FIG. 25C, the optical hybrid circuit of the first example represented a small relative phase deviation over a wide range of wavelengths and shows optical properties which were well coincident with the calculation results shown in FIG. 9B in a qualitative manner. In FIG. 25C, a relative phase deviation in output channels Ch-1 to Ch-3 is represented on the basis of the phase of the output channel Ch-4.

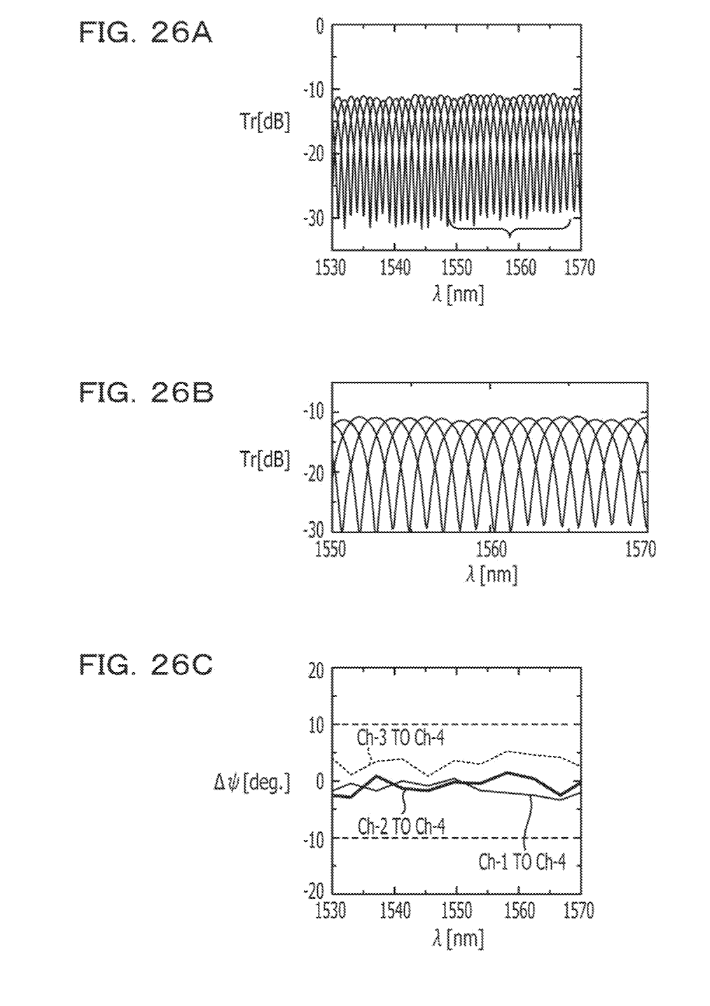

Therefore, the optical hybrid circuit of the first example showed good optical properties in the C band region. An optical hybrid circuit of a second embodiment was obtained in a manner similar to that of the first example, except that the size of each component that made up the optical hybrid circuit was as follows: The width of each of input channels 11 and output channels 12 was 2.0 μm, the distance (gap) between the output channels was 1.0 μm, the width W_{S} was 8.0 μm, and the width W_{M} was 12.0 μm. That is, the optical hybrid circuit of the second embodiment employed the same dimensions as those in the calculation examples shown in FIG. 15A and FIG. 15B. It should be noted that in case of the tested device shown in FIG. 26A, FIG. 26B and FIG. 26C, the delayed interferometer was directly coupled to the two input channels of the optical hybrid circuit.

Continuous-wave (CW) light was input as an input beam into the input channel.

FIG. 26A is a diagram illustrating the transmittance of each output channel of the optical hybrid circuit of the first example and the wavelength of an input signal beam. FIG. 26B is a partially enlarged diagram of FIG. 26A. FIG. 26C is a diagram illustrating the relationship between the relative phase deviation of each output channel and the wavelength of the input signal beam.

As shown in FIGS. 26A and 26B, the optical hybrid circuit of the second embodiment represented good equality of signal-beam dividing and showed optical properties which were well coincident with the calculation results shown in FIG. 15A in a qualitative manner.

Furthermore, as shown in FIG. 26B, the optical hybrid circuit of the second embodiment outputs signal beams from the respective output channels and these output signal beams are phase shifted from one another by π/2 [rad], resulting in the quadrature phase relation.

Therefore, the optical hybrid circuit of the first example showed good optical properties in the C band region.

As shown in FIG. 26C, the optical hybrid circuit of the second example represented a small relative phase deviation over a wide range of wavelengths and shows optical properties which were well coincident with the calculation results shown in FIG. 15B in a qualitative manner. In FIG. 26C, a relative phase deviation in output channels Ch-1 to Ch-3 is represented on the basis of the phase of the output channel Ch-4.

All the examples and conditional terms which have been described herein intend to attain instructive purposes for helping readers to deeply understand the invention and the concept and technology thereof contributed by the present inventors. Therefore, all the examples and conditional terms which have been described herein should be construed without being limited to the specifically described examples and conditions. In addition, the mechanisms exemplified herein are not related to represent the superiority and inferiority of the present invention. The embodiments of the present invention have been described in details. However, various changes, replacements, or modifications thereof should be understood to be carried out unless departing from the spirit and scope of the present invention.

What is claimed is:

1. An optical waveguide device comprising:
two input channels;
a plurality of output channels; and
a multi-mode interference coupler having one end part coupled to the two input channels and the other end part coupled to the plurality of output channels,
the multi-mode interference coupler has a pair of opposite side parts,
the multi-mode interference coupler has a width defined by the pair of opposite side parts and the width gradually increases from one end part to the other end part, and
the two input channels are asymmetrically coupled to the one end part with respect to the center axis in the width direction.

2. The optical waveguide device according to claim 1, wherein
a profile of each of the pair of side parts is linear.

3. The optical waveguide device according to claim 1, wherein
a profile of each of the pair of side parts is parabolic.

4. The optical waveguide device according to claim 1, wherein
a profile of each of the pair of side parts is exponentially curved.

5. The optical waveguide device according to claim 1, wherein
on a printed circuit board, a lower cladding layer is laminated, a core layer is laminated on said lower cladding layer, on said core layer, an upper cladding layer is laminated and said multi-mode interference coupler is formed; and
a thickness of the core layer is constant.

6. The optical waveguide device according to claim 1, wherein
the one end part is divided into four sections in the width direction, and
the two input channels are coupled to two among the sections, which are asymmetrically coupled with respect to the center axis of the multi-mode interference coupler in the width direction.

7. The optical waveguide device according to claim 1, wherein
a multilevel phase-shift keying signal beam is input into one of the plurality of input channels, and
a difference between the light intensities of the respective signal beams output from the plurality of output channels is set to 3 dB or less based on a intensity of the multilevel phase-shift keying signal beam.

8. The optical waveguide device according to claim 1, wherein
the number of the output channels is four.

9. The optical waveguide device according to claim 1, wherein
the optical waveguide device is a monolithic integrated circuit.

10. An optical receiver comprising:
an optical waveguide device that includes:
two input channels;
a plurality of output channels;
a multi-mode interference coupler having one end part coupled to the two input channels and the other end part coupled to the plurality of output channels,
the multi-mode interference coupler has a pair of opposite side parts,
the multi-mode interference coupler has a width defined by the pair of opposite side parts and the width gradually increases from one end part to the other end part, and
the two input channels are asymmetrically coupled to the one end part with respect to the center axis in the width direction.

11. The optical receiver according to claim 10, wherein
the optical waveguide device is a monolithic integrated circuit.

12. The optical receiver according to claim 10, further comprising:
a photoelectric converter that converts each output optical signal from the optical waveguide device into an electrical signal; and
a phase estimation unit that receives each electrical signal output from the photoelectric converter as an input and then estimates the phase of the input electrical signal.

13. A multi-mode interference coupler through which light propagates from one end part to the other end part,
a width between the one end part and the other end part is defined by a pair of side parts and the width is gradually increased from the one end part to the other end part.

14. The multi-mode interference coupler according to claim 13, wherein
the one end part extends outwardly while keeping the width thereof constant and the other end part extends outwardly while keeping the width thereof constant.
